(19) United States
(12) Patent Application Publication
(10) Pub. No.: US 2008/0099585 A1
(43) Pub. Date: May 1, 2008

(54) FUEL INJECTION VALVE

(75) Inventors: Keigo Ohata, Kariya-city (JP); Masatoshi Kuroyanagi, Kariya-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/955,094

(22) Filed: Dec. 12, 2007

(30) Foreign Application Priority Data
Dec. 18, 2006 (JP) 2006-340543
Sep. 18, 2006 (JP) 2006-340542

(51) Int. Cl. B05B 1/30

(52) U.S. Cl. 239/585.5

(57) ABSTRACT

A fuel injection valve includes a housing having an injection hole at a front end thereof, a fuel-collecting chamber that is communicated with the injection hole and is supplied high-pressure fuel from said fuel tank thereto, a pressure control chamber that is disposed on the opposite side of the fuel-collecting chamber with respect to the injection hole and is supplied high-pressure fluid from a supply source of high-pressure fluid thereto, and a valve needle to open and close the injection hole, the valve needle being disposed in the housing. The valve needle has a first pressure-receiving surface to receive fluid pressure in the pressure control chamber. Moreover, the first pressure-receiving surface is formed on the valve needle so that the first pressure-receiving surface faces injection hole side of the pressure control chamber.

### CROSS REFERENCE TO RELATED APPLICATION

This application is based upon, claims priority from and incorporates herein by reference the contents of Japanese Patent Application No. 2006-340542 filed on Dec. 18, 2006 and No. 2006-340543 filed on Dec. 18, 2006.

### FIELD OF THE INVENTION

The present invention relates to a fuel injection valve.

### BACKGROUND OF THE INVENTION

An outwardly opening fuel injection valve is well known, as disclosed in JP-A-11-351098 (corresponding to U.S. Pat. No. 6,224,001 B1). In this type of fuel injection valve, a valve element formed on a valve needle moves outwardly so as to open an injection hole formed around the valve needle in a housing of the fuel injection valve. When the valve element moves outwardly, fuel is jetted through the injection hole. In other words, the fuel injection valve opens when the valve needle moves outwardly.

The fuel injection valve disclosed in JP-A-11-351098 includes a pressure control chamber that generates the power to move the valve needle outwardly and a spring to bias the valve needle inwardly. The pressure control chamber is disposed on the opposite end of the valve needle with respect to the injection hole. With this structure, when pressure in the pressure control chamber increases, the power to move the valve needle outwardly increases. In this case, when the power to move the valve needle outwardly (i.e. toward the direction of opening the fuel injection valve) is larger than the force of the spring to bias the valve needle inwardly (i.e. toward the direction of closing the fuel injection valve), the valve needle moves outwardly and fuel jets from the injection hole.

Generally, the injection hole faces a combustion chamber in an internal combustion engine so as to improve combustion efficiency or to reduce fuel consumption. For the same reason, fuel jetted from the injection hole is atomized. In these cases, the pressure of the fuel supplied to the fuel injection valve is relatively high. Recently, the pressure of the fuel supplied to the fuel injection valve tends to be set higher and higher.

In the above described fuel injection valve, the pressure control chamber faces the end surface on the opposite side of the valve needle with respect to the injection hole. With this structure, when fuel is supplied into the pressure control chamber, the pressure of the fuel in the pressure control chamber is applied to the end surface of the valve needle. As a result, only the power to move the valve needle outwardly, toward the direction of opening the fuel injection valve, is generated.

As above described, nowadays, the pressure of the fuel supplied to the fuel injection valve tends to be set higher. In other words, the power to move the valve needle toward the direction of opening the fuel injection valve tends to increase. Therefore, the power to move the valve needle toward the direction of closing the fuel injection valve needs to increase so as to close the fuel injection valve against that power.

One way to increase the power to move the valve needle toward the direction of closing the fuel injection valve is to increase the force of the spring that biases the valve needle. In this case, the spring needs to be increased in size to increase the biasing force thereof. As a result, the fuel injection valve is increased in size.

### SUMMARY OF THE INVENTION

It is an object of the present invention to provide an improved fuel injection valve that will close effectively without increasing the size of the fuel injection valve.

According to the present invention, a fuel injection valve includes a housing having an injection hole at a front end thereof, a fuel-collecting chamber that is communicated with the injection hole and is supplied high-pressure fuel from a fuel tank thereto, a pressure control chamber that is disposed on the opposite side of the fuel-collecting chamber with respect to the injection hole and is supplied high-pressure fluid from a supply source of high-pressure fluid thereto, and a valve needle to open and close the injection hole, the valve needle being disposed in the housing. The valve needle has a first pressure-receiving surface to receive fluid pressure in the pressure control chamber. Moreover, the first pressure-receiving surface is formed on the valve needle so that the first pressure-receiving surface faces the injection hole side of the pressure control chamber.

### BRIEF DESCRIPTION OF THE DRAWINGS

The above and other objects, features and advantages of the present invention will become more apparent from the following detailed description with reference to the accompanying drawings. In the drawings:

FIG. 1 is a longitudinal cross-sectional view showing a fuel injection valve according to a first embodiment of the present invention;

FIG. 2 is a longitudinal cross-sectional view showing a fuel injection valve shown in FIG. 1, in which a valve needle moves downwardly and a fuel injection valve opens;

FIG. 3 is an enlarged cross-sectional view of a portion around a pressure control chamber of the fuel injection valve shown in FIG. 1;

FIG. 4 is an exploded perspective view of a portion of a valve needle of the fuel injection valve shown in FIG. 1;

FIG. 5 is a cross-sectional view of a rod portion of the valve needle of the fuel injection valve shown in FIG. 1;

FIG. 6 is a plan view of a large-diameter engage portion of the fuel injection valve shown in FIG. 1;

FIG. 7 is a plan view of a large-diameter engage portion of a modified fuel injection valve similar to the fuel injection valve shown in FIG. 1;

FIG. 8 is an exploded cross-sectional view of a portion of a nozzle body of the fuel injection valve shown in FIG. 1;

FIG. 9 is a longitudinal cross-sectional view showing a fuel injection valve according to a second embodiment of the present invention; and

FIG. 10 is a longitudinal cross-sectional view showing a fuel injection valve according to a third embodiment of the present invention.

### DETAILED DESCRIPTION OF THE PREFERRED EMBODIMENTS

### First Embodiment

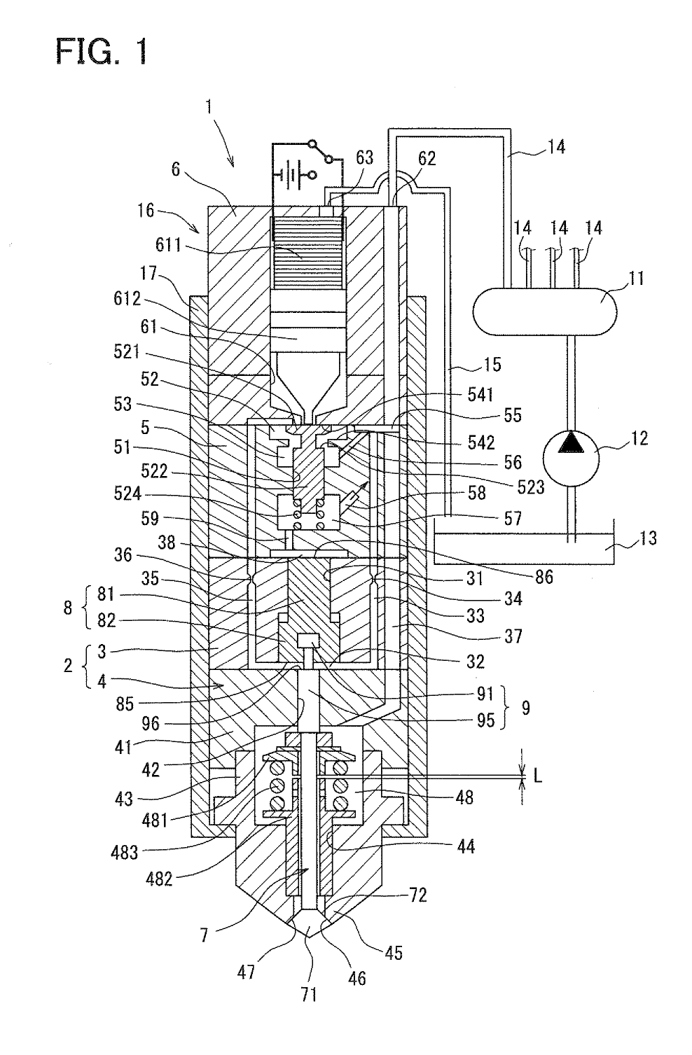

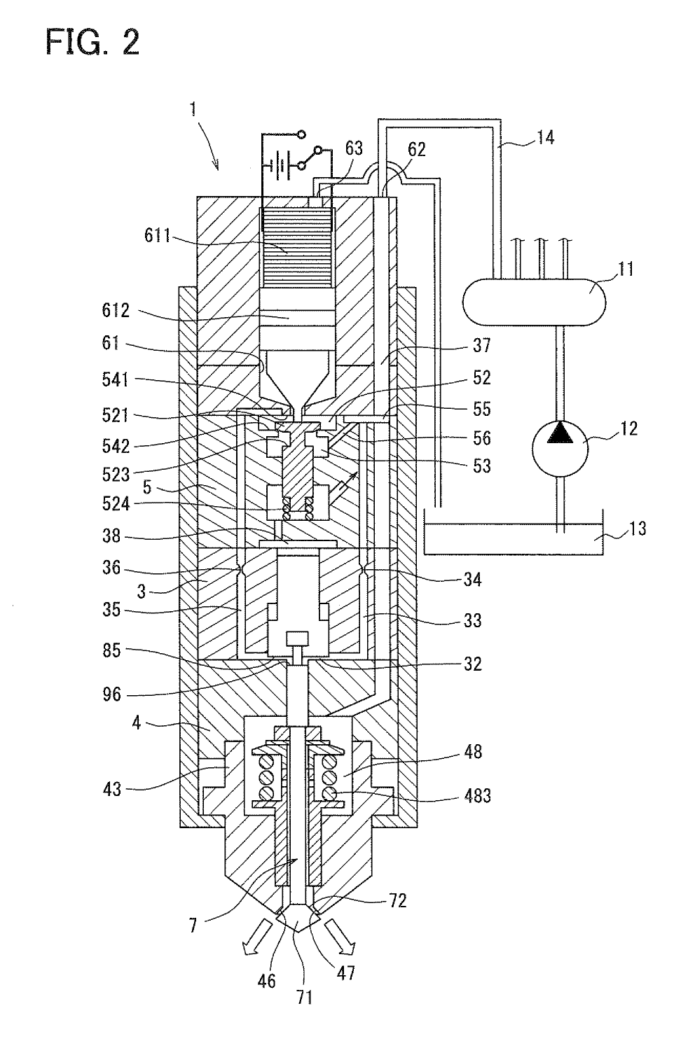

A fuel injection valve 1 according to the first embodiment will be described with reference to FIGS. 1-8.

The fuel injection valve 1 is provided in an engine, for example, a direct injection gasoline engine. The fuel injection valve 1 is disposed in each cylinder of the engine and fuel is supplied to fuel injection valve 1 through a delivery pipe 11 and fuel pipes 14.

The delivery pipe 11 is connected with the fuel pipes 14. The number of the fuel pipes 14 corresponds to the number of fuel injection valves 1 and each fuel pipe 14 is connected to one fuel injection valve 1. Fuel in a fuel tank 13 is pressurized and supplied to the delivery pipe 11 by a fuel supply pump 12. Fuel is stored in the delivery pipe 11 at a predetermined fuel pressure. The control system (not shown) controls an injecting operation of each fuel injection valve 1. Fuel not jetted from the fuel injection valve 1, excessive fuel, flows back to the fuel tank 13 through a return pipe 15.

As shown in FIG. 1, the fuel injection valve 1 is a rod-like shape. Each fuel injection valve 1 is mounted into the cylinder of the engine. Specifically, the fuel injection valve 1 penetrates a sidewall of a combustion chamber of the engine so that a front end of the fuel injection valve 1 is positioned within the cylinder of the engine.

A housing 16 includes a plurality of cylindrically members, specifically, a nozzle body 2, a valve body 5 and a nozzle holder 6. These members 2,5,6 are axially assembled and fixed to each other with a retaining nut 17. Each of these members includes fuel passages and/or spaces therein. Fuel supplied to the fuel injection valve 1 flows through the fuel passages and/or spaces. Moreover, various parts to control fuel flow in the fuel passages are disposed in the fuel passages and/or spaces. Therefore, fuel flowing in the housing 16 is controlled by these various parts, and as a result, the amount of fuel jetted from the fuel injection valve 1 and/or the timing of jetting fuel from the fuel injection valve 1 are controlled.

The nozzle body 2 is disposed closest to the combustion chamber of the engine when the fuel injection valve 1 is mounted in the engine. A valve needle 7 is slidably inserted into the nozzle body 2 so that the valve needle 7 moves axially. The nozzle body 2 includes a proximal piston portion side nozzle body 3 and a distal piston portion side nozzle body 4. Moreover, the distal piston portion side nozzle body 4 includes an upper nozzle body 41 and a lower nozzle body 43.

The proximal piston portion side nozzle body 3 includes a longitudinal hole 31, a first part of a high-pressure fuel passage 33, a first part of a control pressure fuel passage 35, and a first part of a fuel supply passage 37. The longitudinal hole 31 penetrates axially in the proximal piston portion side nozzle body 3. A part of the valve needle 7 is slidably accommodated within the longitudinal hole 31 so that the valve needle 7 moves axially. The longitudinal hole 31 is arranged around the width-wise center of the proximal piston portion side nozzle body 3. The first part of high-pressure fuel passage 33 is arranged outside of the longitudinal hole 31 and penetrates axially in the proximal piston portion side nozzle body 3. The first part of control pressure fuel passage 35 is arranged outside of the longitudinal hole 31 on the opposite side of the first part of high-pressure fuel passage 33 and also penetrates axially in the proximal piston portion side nozzle body 3. The first part of fuel supply passage 37 is arranged outside of the first part of high-pressure fuel passage 33 and also penetrates axially in the proximal piston portion side nozzle body 3. Fuel flowing from the delivery pipe 11 flows through the first part of fuel supply passage 37.

An orifice 34 is disposed in the first part of high-pressure fuel passage 33 and an orifice 36 is disposed in the first part of control pressure fuel passage 35. The inner diameter of the orifice 34 is set smaller than that of the orifice 36. Therefore, The amount of fuel flowing through the orifice 34 is less than the amount of fuel flowing through the orifice 36.

The upper nozzle body 41 of the distal piston portion side nozzle body 4 is arranged below the proximal piston portion side nozzle body 3 and includes a longitudinal hole 42 and a second part of a fuel supply passage 37. The longitudinal hole 42 penetrates axially in the upper nozzle body 41. A central axis of the longitudinal hole 42 is the approximately same as that of the longitudinal hole 31. The longitudinal hole 42 has two portions. Specifically, a first portion slidably supports a part of the valve needle 7 so that the valve needle 7 moves axially, and a second portion accommodates parts to upwardly bias the valve needle 7. The second part of fuel supply passage 37 is communicated with the second portion. The inner diameter of the second portion is set more than that of the first portion.

A pressure control chamber 32 is disposed between the proximal piston portion side nozzle body 3 and the upper nozzle body 41. The pressure control chamber 32 is enclosed with a side surface of the longitudinal hole 31, a side surface of the valve needle 7 and an upper surface of the upper nozzle body 41. The first part of high-pressure fuel passage 33 and the first part of control pressure fuel passage 35 are connected to the pressure control chamber 32, respectively. With this structure, when pressure in the pressure control chamber 32 is controlled, pressure applied to the valve needle 7 is controlled, that is, the power to move the valve needle 7 toward the direction of closing the fuel injection valve is controlled.

Moreover, a low-pressure chamber 38 is disposed on the opposite side of the valve needle 7 with respect to injection hole 46. The low-pressure chamber 38 is enclosed with a large-diameter side surface 86, the longitudinal hole 31 and a lower surface of the valve body 5, as shown in FIG. 1.

The lower nozzle body 43 of the distal piston portion side nozzle body 4 is arranged below the upper nozzle body 41 and includes a longitudinal hole 44. A central axis of the longitudinal hole 44 is approximately the same as that of the longitudinal hole 31 or the longitudinal hole 42.

The longitudinal hole 44 penetrates axially in the lower nozzle body 43 so that the longitudinal hole 44 penetrates the front end 45 of the lower nozzle body 43. With this structure, an opening at the front end 45 of the longitudinal hole 44 is defined as an injection hole 46. A seat portion 47 is formed around the injection hole 46. The valve needle 7 engages the seat portion 47 to close the injection hole 46.

The inner diameter of the longitudinal hole 44 decreases as the injection hole 46 is approached. In the first embodiment, the longitudinal hole 44 includes a large-diameter portion, a medium-diameter portion and a small-diameter portion, as shown in FIG. 1.

When the upper nozzle body 41 and the lower nozzle body are axially assembled and fixed each other, a space for accommodating the above-described parts to upwardly bias the valve needle 7 is formed as a fuel-collecting chamber 48. Specifically, the fuel-collecting chamber 48 accommodates an upper stopper 481, a lower stopper 482 and a coil spring 483. The second part of fuel supply passage 37 is communicated with the fuel-collecting chamber 48, as described above and shown in FIG. 1. Thus, fuel flowing through the supply passage 37 is collected in the fuel-collecting chamber 48. Moreover, the fuel-collecting chamber 48 is communicated with the injection hole 46.

As described above, the longitudinal hole 44 includes a large-diameter portion, a medium-diameter portion and a small-diameter portion. As shown in FIG. 1, the upper stopper 481 is fixed on a step formed on the valve needle 7. The lower stopper 482 is inserted into the medium-diameter portion and fixed on a step formed between the medium-diameter portion and the small-diameter portion. The coil spring 483 is compressed and disposed between the upper stopper 481 and the lower stopper 482. With this structure, the coil spring 483 biases the valve needle 7 upwardly. Moreover, a gap L is formed between the upper stopper 481 and the lower stopper 482 when the valve needle 7 is engaged with the seat portion 47.

The valve body 5 accommodates a control valve 521 to control fuel pressure in the pressure control chamber 32. A control valve chamber 52 to accommodate the control valve 521 therein and a sub-chamber 53 to selectively communicate with the control valve chamber 52 are disposed in the valve body 5. A longitudinal hole 51 is disposed below the sub-chamber 53 and a spring chamber 57 is disposed below the longitudinal hole 51. A communication passage 59 to communicate between the spring chamber 57 and the low-pressure chamber 38 is disposed below the spring chamber 57. The low-pressure chamber 38 is formed on the upper side of the valve needle 7, as described above and shown in FIG. 1.

A return passage 58 communicated with the fuel tank 13 is connected to the spring chamber 57. When the injection hole 46 is closed, pressure in both the spring chamber 57 and the low-pressure chamber 38 is lower than the pressure in each of the control valve chamber 52, the sub-chamber 53, the pressure control chamber 32 and the fuel-collecting chamber 48.

Moreover, a second part of high-pressure fuel passage 33 and a second part of control pressure fuel passage 35 is disposed outside of the control valve chamber 52, the sub-chamber 53, the spring chamber 57, the low-pressure chamber 38, the longitudinal hole 51 and the communication passage 59. A third part of fuel supply passage 37 is disposed outside of the second part of high-pressure fuel passage 33. A distribution passage 55 is disposed on the upper side of the valve body 5 and connects to the second part of high-pressure fuel passage 33 and the third part of fuel supply passage 37. With this structure, fuel that flows from the delivery pipe 11 is divided into fuel flowing through the second part of high-pressure fuel passage 33 and fuel flowing through the third part of fuel supply passage 37. Moreover, a communication passage 56 to communicate between the sub-chamber 53 and the distribution passage 55 is disposed below the distribution passage 55.

With this structure, the distribution passage 55 is disposed near the control valve chamber 52. Accordingly, one port of the high-pressure fuel passage 33 and the other port of the communication passage 56 do not need to be disposed individually. Furthermore, the length of the communication passage 56 can be shortened as much as possible. This simplifies the passage formed in the fuel injection valve 1.

The nozzle holder 6 is disposed above the valve body 5. The nozzle holder 6 accommodates a piezo actuator 611 to drive the control valve 521 and a piston 612 to communicate a displacement to the piezo actuator 611. In the first embodiment, the nozzle holder is comprised of two subcolumner parts. An accommodation hole 61 is disposed in the nozzle holder 6. The lower side of the accommodation hole 61 is communicated with the control valve chamber 52 and the upper side of the accommodation hole 61 is communicated with a discharge port 63. The accommodation hole 61 accommodates the piezo actuator 611 and the piston 612. A fourth part of fuel supply passage 37 is disposed outside of the accommodation hole 61. The fourth part of fuel supply passage 37 has an inlet port 62 at the upper end thereof. The inlet port 62 is connected with the fuel pipe 14. Moreover, the fourth part of the fuel supply passage 37 is connected to the distribution passage 55.

An upper seat portion 541 to engage the control valve 521 is formed on the lower surface of the nozzle holder 6. On the other hand, a lower seat portion 542 to engage the control valve 521 is disposed between the control valve chamber 52 and the sub-chamber 53, as shown in FIG. 1.

The control valve 521 functions as a so-called 2 position 3-way valve. The control valve 521 switches between a first passage to supply fuel in the fuel supply passage 37 to the pressure control chamber 32 and a second passage to supply fuel in the pressure control chamber 32 to a passage for discharging fuel to the return pipe 15.

The control valve 521 has a sub-piston portion 522 on the lower side thereof. A coil spring 524 is disposed below the sub-piston portion 522. The coil spring 524 biases the control valve 521 and the sub-piston portion 522 upwardly. The sub-piston portion 522 is axially and slidably inserted into the longitudinal hole 51. An upper surface 523 of the sub-piston 522 faces the inside of the sub-chamber 53 and a lower surface of the sub-piston 522 faces the inside of the spring chamber 57 that accommodates the coil spring 524.

With this structure, when the piezo actuator 611 is discharged, the piezo actuator 611 contracts. Moreover, the sub-piston portion 522 of the control valve 521 is biased by the coil spring 524. Thus, the piston 612 moves upwardly and engages the upper seat portion 541. When the control valve 521 moves upwardly and engages the upper seat portion 541, a passage between the control valve chamber 52 and the discharge port 63 is closed. As a result, fuel flows through the fuel supply passage 37, the distribution passage 55, the communication passage 56, the sub-chamber 53, the control valve chamber 52 and the control pressure fuel passage 35 (i.e. a first passage).

On the other hand, when the piezo actuator 611 is charged, the piezo actuator 611 extends. Thus, the piston 612 moves downwardly and engages the lower seat portion 542. When the control valve 521 moves downwardly and engages the lower seat portion 542, a passage between the control valve chamber 52 and the sub-chamber 53 is closed. As a result, fuel flows through the pressure control chamber 32, the control pressure fuel passage 35, the control valve chamber 52, the accommodation hole 61 and the discharge port 63 (i.e. a second passage).

With this structure, when fuel is supplied from the delivery pipe 11 through the communication passage 56, fuel pressure is applied to the upper surface 523 of the sub-piston 522. Accordingly, when the control valve 521 moves downwardly, load of the piezo actuator 611 reduces.

As shown in FIG. 1, the valve needle 7 has a valve element 71 on one end thereof. The valve element 71 opens and closes the injection hole 46. When the valve needle 7 moves downwardly, the valve element 71 moves away from the seat portion 47 of the injection hole 46. On the other hand, when the valve needle 7 moves upwardly, the valve element 71 engages the seat portion 47.

Moreover, the valve needle 7 includes a large-diameter piston portion 8 and a small-diameter piston portion 9 on the opposite side of the injection hole 46. The large-diameter piston portion 8 is disposed above the small-diameter piston portion 9, that is, on the opposite side of the small-diameter piston portion 9 with respect to the injection hole 46. These piston portions 8,9 are axially and slidably inserted into the longitudinal hole 31,42, respectively.

The large-diameter piston portion 8 has a slide portion 81 and an engage portion 82 whose outer diameter is larger than that of the slide portion 81. The slide portion 81 and the engage portion 82 are formed as subcolumner shapes, respectively. The slide portion 81 is axially and slidably inserted into the longitudinal hole 31. A gap between the slide portion 81 and the longitudinal hole 31 is set smaller, for example, about 1-5 μm so that fuel in the pressure control chamber 32 cannot leak through the gap. With this structure, the slide portion 81 partitions between the pressure control chamber 32 and the low-pressure chamber 38.

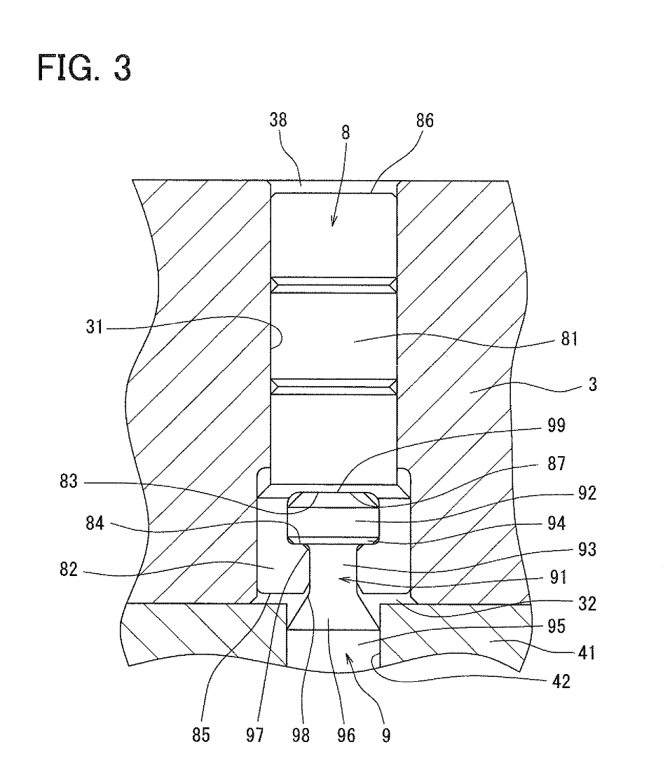

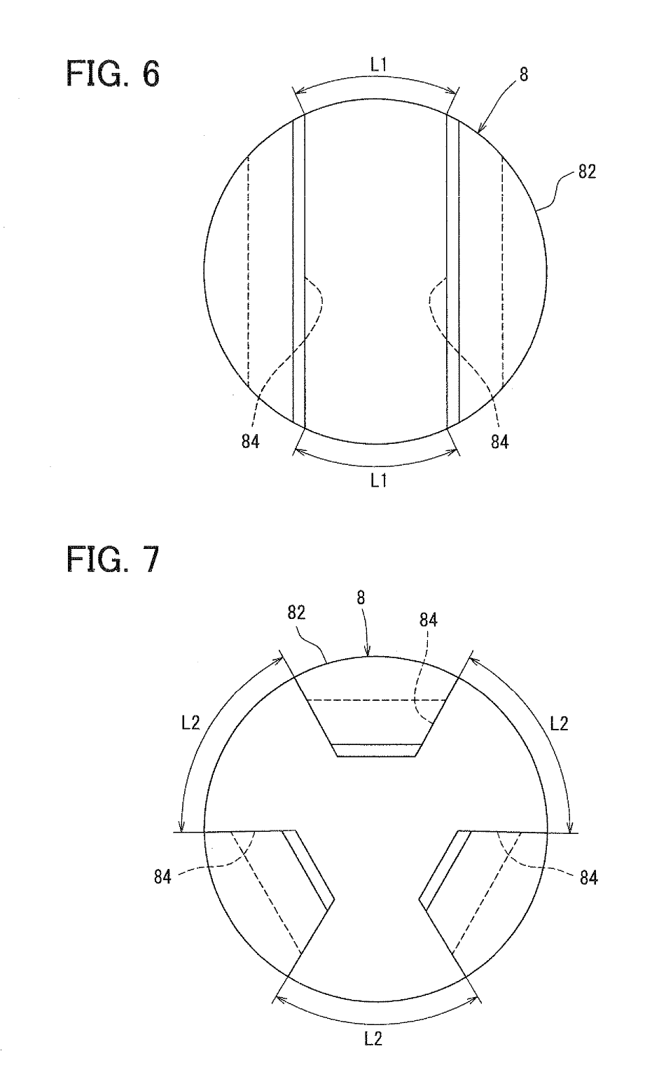

As shown in FIG. 3, the engage portion 82 has a groove portion 83 that opens on the lower side and lateral side thereof. The groove portion 83 has a C-shaped cross section. In other words, the groove portion 83 has a wide upper portion and a narrow lower portion. Engage surfaces 84 to engage an engage portion 91 of the small-diameter piston portion 9 are formed on the inner wall of the groove portion 83. Specifically, the engage surfaces 84 are formed on the borders between the wide upper portion and the narrow lower portion. The engage surfaces 84 face upward and extend toward horizontal direction. As shown in FIG. 6, two engage surfaces 84 are parallel to one another. Incidentally, a distance between two engage surfaces 84 is defined as L1.

The small-diameter piston portion 9 has an engage portion 91 and a slide portion 95 whose outer diameter is larger than that of the engage portion 91. The engage portion 91 and the slide portion 95 are formed as subcolumner shapes, respectively. The slide portion 95 is axially and slidably inserted into the longitudinal hole 42. A gap between the slide portion 95 and the longitudinal hole 42 is set smaller, for example, about 1-5 μm so that fuel in the pressure control chamber 32 cannot leak through the gap.

The engage portion 91 has a head portion 92 and a rod portion 93 that connects the head portion 92 with the slide portion 95. As shown in FIG. 3, the outer diameter of the head portion 92 is larger than that of the rod portion 93. An engage surface 94 is formed on the lower side of the head portion 92 so that the engage surface 94 faces the engage surfaces 84 of the engage portion 82. As shown in FIG. 5, the rod portion 93 is formed as a cylinder having two axially extending planes parallel to each other on the lateral side thereof. A connecting portion 97 to connect the head portion 92 with the rod portion 93 and a connecting portion 98 to connect the rod portion 93 with the slide portion 95 are formed as curved surfaces or chamfered surfaces.

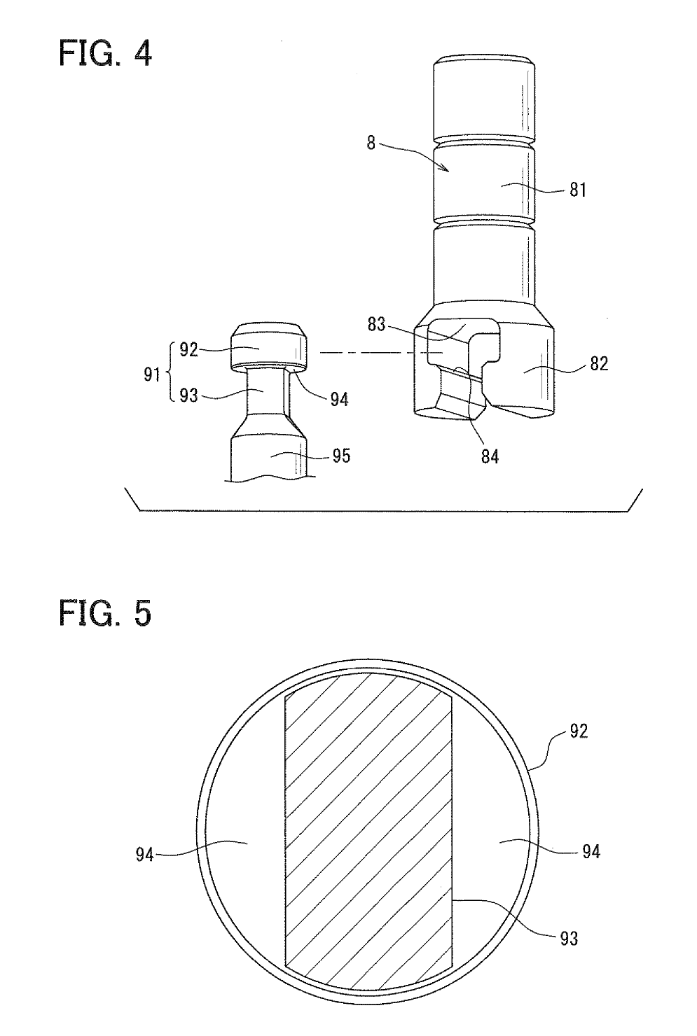

As shown in FIG. 4, when the large-diameter piston portion 8 is connected with the small-diameter piston portion 9, the head portion 92 and the rod portion 93 are inserted into the groove portion 83 of the large-diameter piston portion 8 from the lateral side of large-diameter piston portion 8 so that an upper surface 99 faces the bottom surface 87 of the groove portion 83 and so that the engage surfaces 84 makes contact with the engage surface 94. In this case, the engage surface 94 is covered with the engage surfaces 84. This structure reduces an axial length of the valve needle 7. As a result, this structure reduces a total length of the fuel injection valve 1. With this structure, the engage portion 82 and engage portion 91 are connected with each other. Thus, the valve needle 7 is comprised of the large-diameter piston portion 8 and the small-diameter piston portion 9 and the large-diameter piston portion 8 moves axially with the small-diameter piston portion 9. The engage surfaces 84 make contact with the engage surface 94. Accordingly, the loads on the engage surfaces 84 and the engage surface 94 are dispersed, respectively.

As shown in FIGS. 1 and 3, the valve needle 7 comprised of the large-diameter piston portion 8 and the small-diameter piston portion 9 is disposed in the housing 16 so that a lower surface of the large-diameter piston portion 8 and a upper surface of the small-diameter piston portion 9 face the pressure control chamber 32. When fuel is supplied from the delivery pipe 11 to the pressure control chamber 32 through the high-pressure fuel passage 33, fuel pressure is applied to both a large-diameter pressure-receiving surface 85 formed on the lower surface of the large-diameter engage portion 82 and a small-diameter pressure-receiving surface 96 formed between the slide portion 95 and the rod portion 93. The large-diameter pressure-receiving surface 85 is disposed in the pressure control chamber 32 so that the large-diameter pressure-receiving surface 85 can move toward the injection hole 46.

When the pressure of fuel supplied to the pressure control chamber 32 is at the predetermined pressure, the fuel pressure applied to the large-diameter pressure-receiving surface 85 is equal to the fuel pressure applied to the small-diameter pressure-receiving surface 96. When fuel pressure is applied to the large-diameter pressure-receiving surface 85, power to move the valve needle 7 upwardly is generated on the large-diameter piston portion 8. On the other hand, when fuel pressure is applied to the small-diameter pressure-receiving surface 96, power to move the valve needle 7 downwardly is generated on the small-diameter piston portion 9. A projected area of the large-diameter pressure-receiving surface 85 is larger than that of the small-diameter pressure-receiving surface 96. Accordingly, a power to move the valve needle 7 upwardly is generated on the valve needle 7.

As above described, the low-pressure chamber 38 can be communicated with the fuel tank 13 in which fuel pressure is lower. Therefore, fuel pressure in the pressure control chamber 32 is more than fuel pressure in the low-pressure chamber 38. Thus, the power to move the valve needle 7 upwardly can increase. Specifically, fuel pressure applied to the large-diameter pressure-receiving surface 85 generates power to move the valve needle 7 upwardly on the large-diameter piston portion 8. On the other hand, fuel pressure applied to the small-diameter pressure-receiving surface 96 generates power to move the valve needle 7 downwardly on the small-diameter piston portion 9. The power generated on the large-diameter piston portion 8 is larger than the power generated on the small-diameter piston portion 9. Accordingly, the large-diameter piston portion 8 moves upwardly, pulling the small-diameter piston portion 9.

Pressure in the pressure control chamber 32 can be adjusted by the control valve 521. Thus, the power to move the valve needle 7 upwardly can be adjusted. A part of the fuel supplied to the pressure control chamber 32 flows back to the fuel tank 13 through a gap between the large-diameter piston portion 8 and the longitudinal hole 31, the low-pressure chamber 38, the communication passage 59, the spring chamber 57 and the return passage 58.

In the first embodiment, the power generated by the pressure of fuel applied to a pressure-receiving surface 72 of the valve element 71 and the power generated by the pressure of fuel applied to the large-diameter end surface 86 in the low-pressure chamber 38 make the valve needle 7 move downwardly. On the other hand, the biasing power by the coil spring 483 accommodated in the fuel-collecting chamber 48 and the power generated by the above-described pressure of fuel applied to the end surface 85 of large-diameter piston portion 8 in the pressure control chamber 32 make the valve needle 7 move upwardly.

As above described and shown in FIG. 1, when pressure in the pressure control chamber 32 is equal to pressure in the delivery pipe 11, the power to move the valve needle 7 upwardly is larger than the power to move the valve needle 7 downwardly. In this case, the valve needle 7 moves upwardly.

The balance between the power to move the valve needle 7 upwardly and the power the valve needle 7 downwardly can be adjusted by controlling pressure in the pressure control chamber 32. When pressure in the pressure control chamber 32 decreases, the power to move the valve needle 7 upwardly decreases and is smaller than the power to move the valve needle 7 downwardly. Therefore, the valve needle 7 moves downwardly.

When pressure in the pressure control chamber 32 increases and is equal to pressure in the delivery pipe 11, the power to move the valve needle 7 upwardly is larger than the power to move the valve needle 7 downwardly. Therefore, the valve needle 7 moves upwardly.

In the first embodiment, the large-diameter pressure-receiving surface 85 of the large-diameter piston portion 8 faces the inside of the pressure control chamber 32. With this structure, pressure in the pressure control chamber 32 is applied to the valve needle 7 so that the valve needle 7 moves upwardly. Compared with the above-described conventional fuel injection valve, the valve element 71 engages the seat portion 47 more tightly to close the injection hole 46 without increasing the size of the coil spring 483.

In the first embodiment, the power to move the valve needle 7 upwardly is adjusted by controlling pressure in the pressure control chamber 32. Accordingly, the moving of the valve needle 7 is controlled without other kinds of devices to move the valve needle 7.

In the first embodiment, the outer diameter of the engage portion 82 is larger than that of the slide portion 81. Thus, the area of the engage surfaces 84 to engage the engage surface 94 can be set larger. Therefore, the loads on the engage surfaces 84 and the engage surface 94 are dispersed, respectively.

As above described and shown in FIG. 5, the rod portion 93 is formed as a cylinder having two axially extending planes parallel to each other on the lateral sides thereof. This structure can keep the desired area of the surface to form the engage surface 94 on the lower side of the head portion 92. Moreover, this structure can keep the cross section of the rod portion 93 as large as possible. Therefore, this reduces a decrease in the strength of the rod portion 93.

As described above and shown in FIG. 3, the connecting portion 97 and the connecting portion 98 are formed as curved surfaces or chamfered surfaces. Therefore, stress concentration generated in each connecting portion 97,98 is alleviated when the large-diameter piston portion 8 moves upwardly, pulling the small-diameter piston portion 9.

As above described and shown in FIG. 6, the two engage surfaces 84 are parallel to one another. With this structure, when the valve needle 7 moves upwardly or downwardly as the engage surfaces 84 make contact with and engage the engage surface 94, both piston portions 8,9 are stably connected with each other, and furthermore, the valve needle 7 can move smoothly.

Incidentally, in the above embodiments, two engage surfaces 84 are provided. However, three engage surfaces (as shown in FIG. 7), or more than three engage surfaces, may be provided. In this case, it is preferred that the distance L2 between the adjacent engage surfaces is the same.

As shown in FIG. 1, when the piezo actuator 611 is discharged, the piezo actuator 611 contracts and the piston 612 moves upwardly. Accordingly, the control valve 521 moves upwardly by the force of the coil spring 524 and engages the upper seat portion 541.

Subsequently, when fuel pressurized at a predetermined fuel pressure is supplied from the delivery pipe 11 to the fuel supply passage 37 through the inlet port 62, the fuel is supplied to the fuel-collecting chamber 48. Moreover, the fuel is supplied to the pressure control chamber 32 both through the high-pressure fuel passage 33 and through the communication passage 56, the sub-chamber 53, the control valve chamber 52 and the control pressure fuel passage 35.

When fuel is supplied to the fuel-collecting chamber 48 and the pressure control chamber 32, the power to move the valve needle 7 downwardly is generated by the pressure of fuel applied to the pressure-receiving surface 72. At the same time, the power to move the valve needle 7 upwardly is generated by the pressure of fuel applied to the large-diameter pressure-receiving end surface 85 less the pressure of fuel applied to the small-diameter pressure-receiving end surface 96. Moreover, the power to move the valve needle 7 upwardly is generated by the force of the coil spring 483. In this case, the power to move the valve needle 7 upwardly is larger than the power to move the valve needle 7 downwardly. Therefore, the valve needle 7 moves upwardly, and as a result, the valve element 71 engages the seat portion 47 (as shown in FIG. 1).

Subsequently, when the piezo actuator 611 is charged, the piezo actuator 611 extends and the piston 612 moves downwardly. Accordingly, the control valve 521 moves downwardly and engages the lower seat portion 542.

When the control valve 521 engages the lower seat portion 542, a passage between the control valve chamber 52 and the sub-chamber 53 is closed. As a result, fuel flows through the pressure control chamber 32, the control pressure fuel passage 35, the control valve chamber 52, the accommodation hole 61 and the discharge port 63. Thus, fuel in the pressure control chamber 32 is discharged from the discharged port 63 to the outside of the fuel injection valve 1. In the first embodiment, fuel is supplied to the pressure control chamber 32 through the high-pressure fuel passage 33. However, the inner diameter of the orifice 34 disposed in the high-pressure fuel passage 33 is set smaller than that of the orifice 36 disposed in the control pressure fuel passage 35. Therefore, pressure in the pressure control chamber 32 decreases.

As a result, the power to move the valve needle 7 downwardly is larger than the power to move the valve needle 7 upwardly and the valve needle 7 moves downwardly. Thus, the valve element 71 moves away from the seat portion 47. Accordingly, fuel in the fuel-collecting chamber 48 is jetted out of the fuel injection valve 1 from the injection hole 46.

When the predetermined amount of fuel is jetted from the injection hole 46 and subsequently the piezo actuator 611 is discharged again, the valve element 71 engages the seat portion 47, as described above. Accordingly, fuel injection from the injection hole 46 is stopped. In the first embodiment, there are two kinds of passages to supply fuel to the pressure control chamber 32, as above described. Thus, pressure in the pressure control chamber 32 can be restored relatively quickly. Therefore, the valve needle 7 can be moved upwardly quickly. This can improve closing characteristics of fuel injection valve.

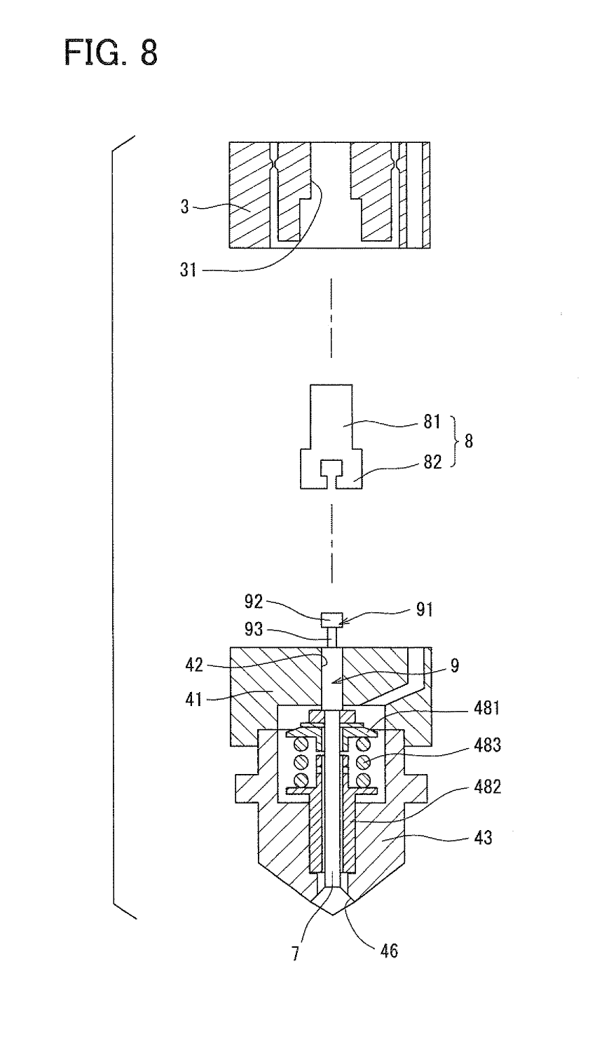

Hereinafter, a manufacturing procedure of the fuel injection valve 1 is described with reference to FIG. 8.

Firstly, a part of the valve needle 7 (without the large-diameter piston portion 8) is inserted into the lower nozzle body from the injection hole 46 because the fuel injection valve 1 is an outwardly opening type of fuel injection valve. Specifically, the small-diameter piston portion 9 is inserted into the lower nozzle body 43 from the injection hole 46.

Secondly, the lower stopper 482, the coil spring 483 and the upper stopper 481 are sequentially fitted on the valve needle 7 from the upper side of the valve needle 7. Subsequently, the upper nozzle body 41 is put on the lower nozzle body 43 so that the lower nozzle body 43 is covered with the upper nozzle body 41. In this case, the small-diameter engage portion 91 protrudes from the upper surface of the upper nozzle body 41, as shown in FIG. 8.

Thirdly, the large-diameter engage portion 82 and the small-diameter engage portion 91 are connected with each other, as shown in FIG. 4. Subsequently, the proximal piston portion side nozzle body 3 is put on the upper nozzle body 41 by inserting the large-diameter slide portion 81 into the longitudinal hole 31.

Fourth, the valve body 5 including the control valve 521 and the nozzle holder 6 including the piezo actuator 611 is sequentially put on the proximal piston portion side nozzle body 3 from the upper side thereof. Finally, the distal piston portion side nozzle body 4, the proximal piston portion side nozzle body 3, the valve body 5 and the nozzle holder 6 are integrally fixed each other with a retaining nut 17.

In the first embodiment, the valve needle 7 is comprised of the large-diameter piston portion 8 having the large-diameter slide portion 81 and the small-diameter piston portion 9 having the small-diameter slide portion 95.

As above described, the large-diameter piston portion 8 can be separated from the valve needle 7. With this structure, each piston portion 8,9 is slidably accommodated in the longitudinal hole 31,42, individually. With this structure, the valve needle 7 can be easily inserted into the nozzle body 2 even through the outer diameter of the upper side of the valve needle 7 is larger than that of the lower side thereof.

Furthermore, the outer diameter of the head portion 92 is smaller than that of the small-diameter slide portion 95. Thus, the small-diameter piston portion 9 can be smoothly inserted into the longitudinal hole 42 without being caught on the inner surface of the longitudinal hole 42.

In the first embodiment, the nozzle body 2 is comprised of the proximal piston portion side nozzle body 3 having the longitudinal hole 31 and the distal piston portion side nozzle body 4 having the longitudinal hole 42. With this structure, it is possible that an axis of the longitudinal hole 31 is not consistent with an axis of the longitudinal hole 42. However, the dimension tolerance of large-diameter piston portion 8 and small-diameter piston portion 9 is set to form a gap between the side surface of head portion 92 and rod portion 93 and the inner surface of the groove portion 83 when the large-diameter piston portion 8 is connected with the small-diameter piston portion 9. With this structure, any mismatch between the axis of the longitudinal hole 31 and the axis of the longitudinal hole 42 can be absorbed. Accordingly, the slide portion 81 and the slide portion 95 can slide stably.

### Second Embodiment

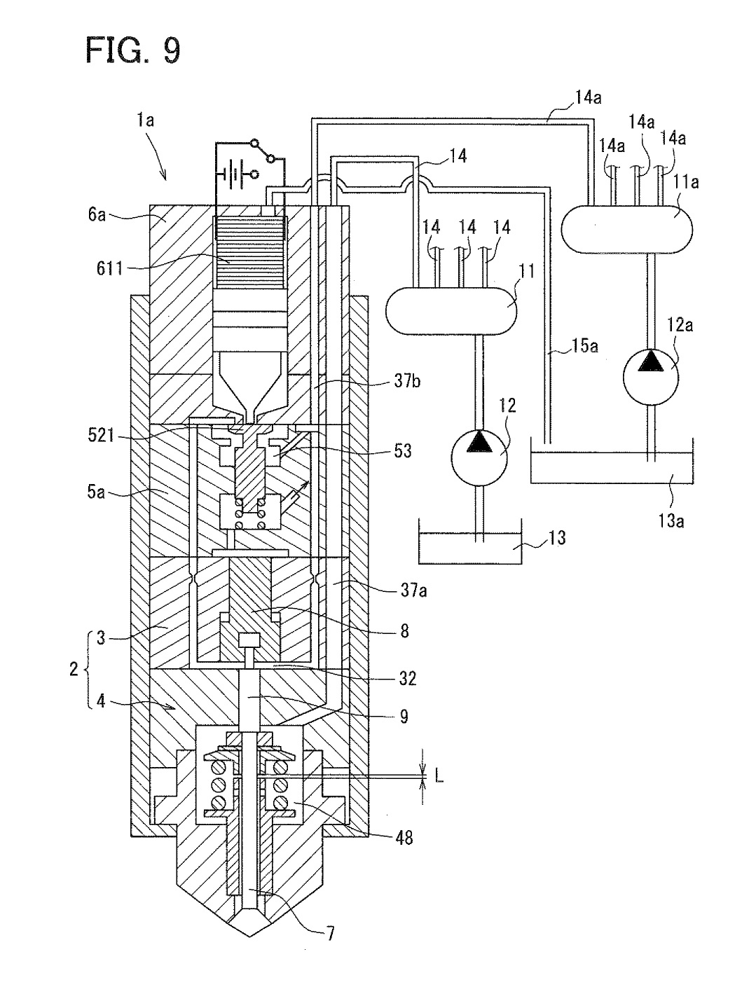

A fuel injection valve according to the second embodiment will be described with reference to FIG. 9. The same or similar reference numerals hereafter indicate the same or substantially the same part, portion or component as the first embodiment.

In the second embodiment, fluid supplied to the pressure control chamber 32 is different from fluid supplied to the fuel-collecting chamber 48. For example, another kind of high-pressure fluid (working fluid) is supplied to the pressure control chamber 32 and fuel in the delivery pipe 11 is supplied to the fuel-collecting chamber 48, as shown in FIG. 9.

Specifically, fuel injection valve 1a has a delivery pipe 11a. Working fluid is supplied from the working fluid tank 13a to the pressure control chamber 32 and the sub-chamber 53 through the delivery pipe 11a, a working fluid pipe 14a and a working fluid supply passage 37b that is different from a fuel supply passage 37a to supply fuel to the fuel-collecting chamber 48. Working fluid in the working fluid tank 13a is pressurized and supplied to the delivery pipe 11a by a fluid supply pump 12a. Working fluid is stored in the delivery pipe 11a at a predetermined fluid pressure. In the second embodiment, excessive working fluid discharged from the pressure control chamber 32 and the sub-chamber 53 flows back to the working fluid tank 13a through a return pipe 15a.

### Third Embodiment

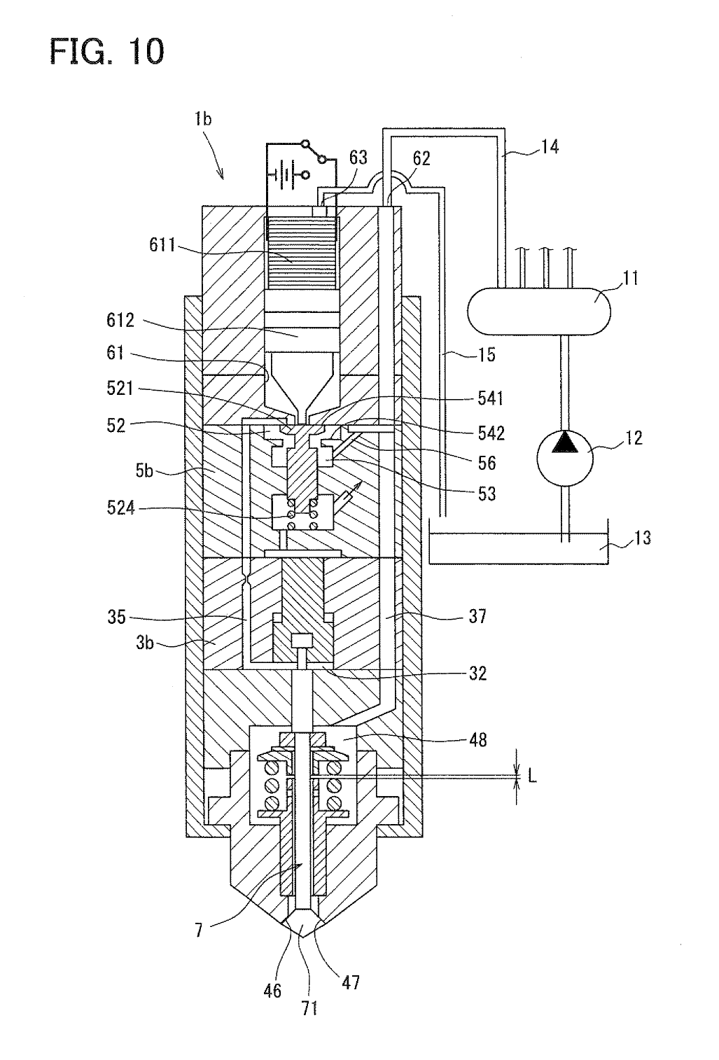

A fuel injection valve according to the third embodiment will be described with reference to FIG. 10. As shown in FIG. 10, a fuel injection valve 1b does not have a high-pressure fuel passage corresponding to the high-pressure fuel passage 33 described in the first embodiment. Hereinafter, an operation of the fuel injection valve 1b is described.

As shown in FIG. 10, when the piezo actuator 611 is discharged, the piezo actuator 611 contracts and the piston 612 moves upwardly. Accordingly, the control valve 521 moves upwardly by the force of the coil spring 524 and engages the upper seat portion 541.

Subsequently, when fuel pressurized at a predetermined fuel pressure is supplied from the delivery pipe 11 to the fuel supply passage 37 through the inlet port 62, the fuel is supplied to the fuel-collecting chamber 48. Moreover, the fuel in the fuel supply passage 37 is supplied to the pressure control chamber 32 through the communication passage 56, the sub-chamber 53, the control valve chamber 52 and the control pressure fuel passage 35.

When fuel is supplied to the fuel-collecting chamber 48 and the pressure control chamber 32, the valve needle 7 moves upwardly and the valve element 71 engages the seat portion 47, as described in the first embodiment. Therefore, fuel injection from the injection hole 46 is stopped.

Subsequently, when the piezo actuator 611 is charged, the piezo actuator 611 extends and the piston 612 moves downwardly. Accordingly, the control valve 521 moves downwardly and engages the lower seat portion 542.

When the control valve 521 engages the lower seat portion 542, a passage between the control valve chamber 52 and the sub-chamber 53 is closed. As a result, fuel flows through the pressure control chamber 32, the control pressure fuel passage 35, the control valve chamber 52, the accommodation hole 61 and the discharge port 63. Thus, fuel in the pressure control chamber 32 is discharged from the discharged port 63 to the outside of the fuel injection valve 1 and pressure in the pressure control chamber 32 decreases.

As a result, the valve needle 7 moves downwardly, as described in the first embodiment. Thus, the valve element 71 moves away from the seat portion 47. Accordingly, fuel in the fuel-collecting chamber 48 is jetted out of the fuel injection valve 1 from the injection hole 46.

When the predetermined amount of fuel is jetted from the injection hole 46 and subsequently the piezo actuator 611 is discharged again, the valve element 71 moves upwardly and engages the seat portion 47. Accordingly, fuel injection from the injection hole 46 is stopped.

In the third embodiment, the fuel injection valve 1b does not have a high-pressure fuel passage corresponding to the high-pressure fuel passage 33 described in the first embodiment. With this structure, when fuel in the pressure control chamber 32 is discharged, new high-pressure fuel is not supplied to the pressure control chamber 32. This reduces the loss of the fuel pressure in the delivery pipe 11.

Various other modifications and alternations may be made to the above embodiments without departing from the spirit of the present invention. Thus, while the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A fuel injection valve for injecting high-pressure fuel supplied from a fuel tank, the fuel injection valve comprising;
a housing having an injection hole at a front end thereof;
a fuel-collecting chamber that is communicated with the injection hole and is supplied with high-pressure fuel from said fuel tank thereto;
a pressure control chamber that is disposed on the opposite side of the fuel-collecting chamber with respect to the injection hole and is supplied high-pressure fluid from a supply source of high-pressure fluid thereto; and
a valve needle to open and close the injection hole, the valve needle being disposed in the housing, the valve needle having a first pressure-receiving surface to receive fluid pressure in the pressure control chamber;
wherein:
the first pressure-receiving surface is formed on the valve needle so that the first pressure-receiving surface faces an injection hole side of the pressure control chamber.

2. The fuel injection valve according to claim 1, wherein:
the housing has a longitudinal hole to accommodate the valve needle; and
the valve needle extends between the fuel-collecting chamber and the pressure control chamber.

3. The fuel injection valve according to claim 2, further comprising:
a low-pressure chamber that is disposed on the opposite side of the pressure control chamber with respect to the injection hole;
wherein:
pressure in the pressure control chamber is equal to or greater than pressure in the low-pressure chamber.

4. The fuel injection valve according to claim 3, wherein:
the low-pressure chamber can be communicated with the supply source of high-pressure fluid.

5. The fuel injection valve according to claim 1, wherein:
the valve needle includes a second pressure-receiving surface to receive fuel pressure in the fuel-collecting chamber so that the valve needle moves toward the side of the injection hole by said fuel pressure applied thereto;
the housing includes a first passage to supply high-pressure fluid to the pressure control chamber and to discharge high-pressure fluid from the pressure control chamber to the fuel tank, a second passage to supply high-pressure fuel to the fuel-collecting chamber, and a control valve chamber that is disposed along said first passage and accommodates a control valve to control pressure in the pressure control chamber; and
the control valve switches between a supply passage to supply high-pressure fluid to the pressure control chamber and a discharge passage to discharge high-pressure fluid from the pressure control chamber.

6. The fuel injection valve according to claim 5, wherein:
the first passage includes a first connecting passage to constantly communicate between the pressure control chamber and the supply source of high-pressure fluid and a second connecting passage that connects between the fuel tank and the pressure control chamber; and
the second connecting passage is communicated between the fuel tank and the pressure control chamber when the control valve is open.

7. The fuel injection valve according to claim 6, wherein:
the amount of high-pressure fluid discharged from the pressure control chamber to the supply source of high-pressure fluid through the second connecting passage is set more than the amount of high-pressure fluid supplied to the pressure control chamber through the first connecting passage.

8. The fuel injection valve according to claim 6, wherein:
the housing includes a sub-chamber connecting with the control valve chamber and a communication passage to constantly communicate between said sub-chamber and the supply source of high-pressure fluid; and
the communication passage is communicated with the second connecting passage when the control valve is closed.

9. The fuel injection valve according to claim 8, wherein:
the housing includes a distribution passage to divide high-pressure fluid into fluid flowing through the first connecting passage and fluid flowing through the communication passage; and
said distribution passage is disposed near the control valve chamber.

10. The fuel injection valve according to claim 8, wherein:
the control valve includes a sub-piston portion that faces the sub-chamber; and
the sub-piston portion has a third pressure-receiving surface that faces the inside of the sub-chamber.

11. The fuel injection valve according to claim 2, wherein:
the valve needle includes a large-diameter piston portion that moves axially in the longitudinal hole, a small-diameter piston portion whose outer diameter is smaller than the outer diameter of the large-diameter piston portion and a connecting portion to connect the large-diameter piston portion with the small-diameter piston portion;
the large-diameter piston portion is disposed on the opposite side of the small-diameter piston portion with respect to the injection hole and has the first pressure-receiving surface at the end surface of the injection hole side of the large-diameter piston portion.

12. The fuel injection valve according to claim 1, wherein:
said high-pressure fluid is the same as the high-pressure fuel; and
the supply source of high-pressure fluid is the fuel tank.

13. The fuel injection valve according to claim 11, wherein:
the large-diameter piston portion has a slide portion that is axially and slidably inserted into the longitudinal hole;
the small-diameter piston portion has a slide portion that is axially and slidably inserted into the longitudinal hole;
the pressure control chamber is disposed between the slide portion of the large-diameter piston portion and the slide portion of the small-diameter piston portion;
the connecting portion has a recessed portion and a protruding portion to engage the recessed portion;
the recessed portion is formed at the end surface of the injection hole side of the large-diameter piston portion; and
the protruding portion is formed at the end surface on the side of the small-diameter piston portion opposite the injection hole side thereof.

14. The fuel injection valve according to claim 13, wherein:
a maximum outer diameter of the protruding portion is smaller than a diameter of the slide portion of the small-diameter piston portion.

15. The fuel injection valve according to claim 13, wherein:
the protruding portion includes a head portion, a rod portion whose outer diameter is smaller than the outer diameter of the head portion and a first engage surface formed between the head portion and the rod portion; and
the recessed portion includes a second engage surface that faces the first engage surface of the protruding portion to make contact with the first engage surface when the large-diameter piston portion moves with pulling the small-diameter piston portion.

16. The fuel injection valve according to claim 13, wherein:
the recessed portion is formed as a diametrically extending groove with respect to the large-diameter piston portion.

17. The fuel injection valve according to claim 13, wherein:
the protruding portion and the recessed portion are connected with each other with a gap therebetween when the large-diameter piston portion is connected with the small-diameter piston portion.

18. The fuel injection valve according to claim 15, wherein:
a first sub-connecting portion to connect the head portion with the rod portion and a second sub-connecting portion to connect the rod portion with the small-diameter slide portion are formed as curved or chamfered surfaces.

19. The fuel injection valve according to claim 15, wherein:
there are at least two second engage surfaces on the recessed portion; and
the two engage surfaces are parallel to one another.

20. The fuel injection valve according to claim 15, wherein:
the outer diameter of a portion in which the second engage surface is formed is larger than that of the slide portion of the large-diameter piston portion.

21. The fuel injection valve according to claim 13, wherein:
the end surface on the injection hole side of the large-diameter piston portion and the end surface of the small-diameter piston portion on the side opposite the injection hole thereof face the inside of the pressure control chamber, respectively.
